(19) United States
(12) Patent Application Publication
(10) Pub. No.: US 2026/0175474 A1
(43) Pub. Date: Jun. 25, 2026

(54) CORE-BACK INJECTION MOLDING OF INTERIOR PLASTIC COMPONENTS USING RAPID HEATING AND COOLING SYSTEM

(71) Applicant: GM GLOBAL TECHNOLOGY OPERATIONS LLC, Detroit, MI (US)

(72) Inventors: Israel LOPEZ-GONZALEZ, Warren, MI (US); Ramon Andres CORDERO, Sterling Heights, MI (US); Jaime S. HOLLATZ, Clarkston, MI (US)

(21) Appl. No.: 18/988,273

(22) Filed: Dec. 19, 2024

(51) Int. Cl. B29C 44/08; B29C 44/34; B29C 44/58; B29K 105/04

(52) U.S. Cl. CPC B29C 44/086; B29C 44/3446; B29C 44/586; B29K 2105/04

(57) ABSTRACT

A core-back injection molding tool includes a positioning device is configured to move at least one of a first mold half and a second mold half, a molten plastic source and a chemical foaming agent (CFA) source. A liquid delivery system delivers first or second liquids having a first or second temperature to a channel defined in the first mold half. A controller supplies the first liquid to the channel of the first mold half; closes the first second mold halves using the positioning device; supplies a mixture of a molten plastic and CFA from the CFA to the cavity; opens at least one of the first and second mold halves by a predetermined distance using the positioning device; supplies the second liquid to the channel of the first mold half; opens the mold using the positioning device; and ejects a molded part.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to injection molding of parts, and more particularly to a core-back injection molding system.

Parts such as automotive interior or exterior panels can be made using an injection molding process. A molding tool includes a cavity defining an inverse shape of a molded part. Molten plastic is injected into the cavity and the part is molded. The molded part is ejected from the mold and the process is repeated.

### SUMMARY

A core-back injection molding tool includes a mold including a first mold half and a second mold half defining a cavity there between. A positioning device is configured to move at least one of the first mold half and the second mold half. The core-back injection molding tool includes a molten plastic source and a chemical foaming agent (CFA) source. A liquid delivery system is configured to deliver one of a first liquid having a first temperature and a second liquid having a second temperature to a channel defined in the first mold half. A controller is configured to supply the first liquid from the liquid delivery system to the channel of the first mold half; close the first mold half and the second mold half using the positioning device; supply a mixture of a molten plastic from the molten plastic source and CFA from the CFA source to the cavity; open one of the first mold half and the second mold half by a predetermined distance using the positioning device; supply the second liquid from the liquid delivery system to the channel of the first mold half; open the mold using the positioning device; and eject a molded part.

In other features, the first temperature is in a range from 200° F. to 250° F. The second temperature is in a range from 32° F. to 90° F. The CFA comprises 0.5 wt % to 5 wt % of the mixture.

In other features, the molded part has a finished side and an opposite side, the first mold half corresponds to the finished side, and the liquid delivery system selectively delivers the first liquid and the second liquid to the first mold half. The second mold half is moved the predetermined distance relative to the first mold half. The predetermined distance is in a range from 0.5 mm to 1.5 mm.

In other features, one of the first mold half and the second mold half includes a first channel arranged around the cavity, a flexible seal material is arranged in the first channel, and the flexible seal material is rated for use at a temperature greater than or equal to 250° F.

In other features, a portion of the cavity of the first mold half includes a surface grain having a depth that is in a range from 70% to 85% of a final grain depth of the molded part. A liquid source is configured to deliver a third fluid to channels of the second mold half. A third temperature of the third fluid is less than the first temperature of the first liquid and greater than the second temperature of the second liquid.

A method for molding a part includes providing a mold including a first mold half and a second mold half defining a mold cavity there between; supplying a first liquid having a first temperature to a channel of the first mold half; closing the first mold half and the second mold half; supplying a mixture including molten plastic and a chemical foaming agent (CFA) to the mold cavity; opening one of the first mold half and the second mold half by a predetermined distance; supplying a second liquid having a second temperature less than the first temperature to the channel of the first mold half; opening the mold; and ejecting the part.

In other features, the first temperature is in a range from 200°F to 250°F. The second temperature is in a range from 32° F. to 90° F. The CFA comprises 0.5 wt % to 5 wt % of a mixture. The molded part has a finished side and an opposite side, the first mold half corresponds to the finished side, and the first liquid and the second liquid are delivered to the first mold half.

In other features, the second mold half is moved by the predetermined distance relative to the first mold half. The predetermined distance is in a range from 0.5 mm to 1.5 mm. A portion of the mold cavity of the first mold half includes a surface grain having a depth that is in a range from 70% to 85% of a final grain depth of the molded part.

In other features, the method includes delivering a third fluid to a channel defined by the second mold half. A third temperature of the third fluid is less than the first temperature of the first liquid and greater than the second temperature of the second liquid.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a core-back molding tool including a mold and a liquid delivery system performing rapid heating and cooling of the mold according to the present disclosure;

FIG. 2 is a side cross section of an example of a cavity surface defining a surface grain of the molded part;

FIG. 3A is a functional block diagram of an example of a positioning device and a source supplying a mixture including molten plastic and a chemical foaming agent (CFA) for the core-back molding tool according to the present disclosure;

FIG. 3B is a plan view of one of the mold halves including a first channel to receive a flexible mold material and a second channel that is selectively attached to a vacuum source according to the present disclosure;

FIG. 4 is a functional block diagram of an example of a controller configured to control the core-back injection molding process according to the present disclosure; and

FIG. 5 is a flowchart of an example of a method for core-back injection molding of parts according to the present disclosure.

In the drawings, reference numbers may be reused to identify similar and/or identical elements.

### DETAILED DESCRIPTION

While the present disclosure is related to core-back injection molding of parts for vehicles, the injection molded parts can be used in other applications.

Core-back injection molding can be used for reducing the weight of plastic molded parts such as interior or exterior automotive components. The mold includes a first mold half (e.g., a cavity side) and a second mold half (e.g., a core side). A heated liquid (e.g., water at 120° F.) is circulated within the first mold half to heat the cavity side of the mold. A liquid (e.g., water at ˜100° F. or approximately 20 ° F. less than the first mold half) is circulated in the second mold half to control a temperature of the core side. The mold is closed and a mixture including molten plastic and a chemical foaming agent (CFA) are supplied to the cavity. One of the mold halves (e.g., the core side) is drawn back by a predetermined distance (e.g., 0.5 mm to 1.5 mm) after the mixture is supplied. After a predetermined period, the mold halves are opened and the part is ejected. The process may be repeated for one or more additional parts.

Typically, the molded parts for vehicle applications may include an exposed surface and a backside surface. The exposed surface may often need to be a class A surface. However, the core-back molding process described above produces surface defects in class A surfaces. As a result, the molded parts need to be painted in a secondary operation to improve the quality of the surface, which increases manufacturing cost.

The present disclosure relates to core-back injection molding tool using a liquid delivery system to rapidly heat and cool the cavity side of the mold. During molding, the temperature of the first mold half is rapidly heated by a first liquid heated above a temperature of a conventional injection molding process. In some examples, the first liquid is supplied at a temperature in a range from 200° F. to 250° F. After one side of the mold is drawn back from the other side, the rapid heating and cooling system supplies a second liquid at a temperature in a range from 32° F. to 90° F. to rapidly cool the cavity side of the mold.

The use of the fluid delivery system in conjunction with a core-back injection molding tool minimizes class A surface defects. As a result, lighter parts can be produced with high quality and improved appearance without the need for a secondary process such as painting.

Referring now to FIG. 1, a mold 10 includes a first mold half 10-A (e.g., a cavity side) corresponding to a finished surface and a second mold half 10-B (e.g., a core side) corresponding to a back surface. The first mold half 10-A includes channels 12 for receiving a heated or cooled liquid such as water or oil from a liquid delivery system 13. The second mold half 10-A includes channels 14 for receiving fluid from a liquid source.

A liquid delivery system 13 provides rapid heating and cooling by supplying a first liquid having a first temperature during a first portion of a mold cycle (e.g., during injection of a mixture of molten plastic and CFA) and a second liquid having a second temperature less than the first temperature during a second portion of the mold cycle (e.g., after draw back). The liquid delivery system 13 includes a first set of valves 38 and channels 34 and 36 selectively connecting a first liquid source 30 to the first mold half 10-A, a second set of valves 68 and channels 64 and 66 connecting a second liquid source 60 to the first mold half 10-A, and crossover channels 37.

The first liquid source 30 may include a heater 44 and a temperature sensor 42 to control a first temperature of the first liquid in the first liquid source 30. The second liquid source 60 may include a chiller 74 and a temperature sensor 72 to control a second temperature of the second liquid in the second liquid source 60. In some examples, the liquid delivery system 13 comprises a Variotherm Temperature Control System available from Single Group in Germany, although other systems can be used.

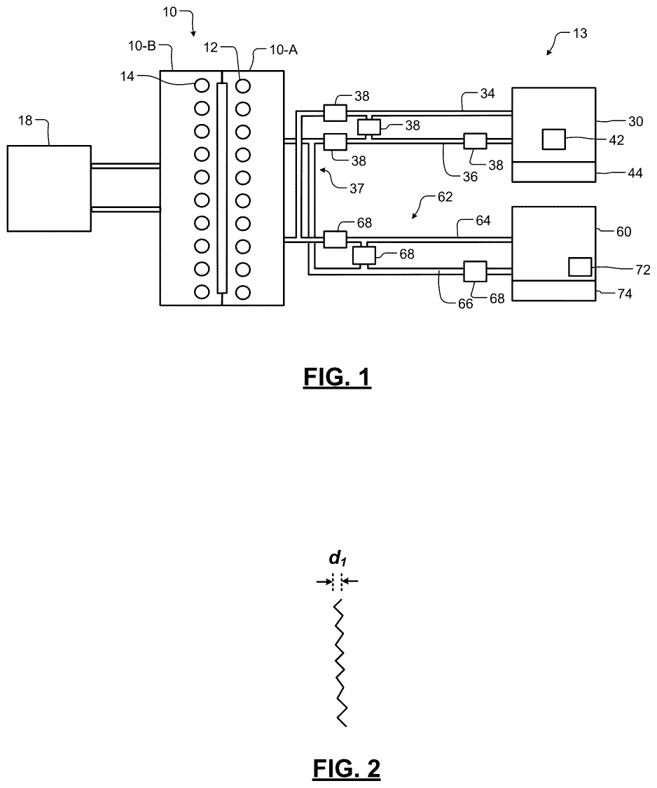

Referring now to FIG. 2, an enlarged portion of a surface of a cavity 90 is shown. The cavity 90 defines surface grains of a finished surface. The surface grains have a depth d1 that is in a range from 70% to 85% of a depth of a final surface grain of the molded part. When operating at a higher temperature, the depth of the surface grain of the molded part increases. To offset the increase, the grain depth defined by the cavity is decreased to provide compensation.

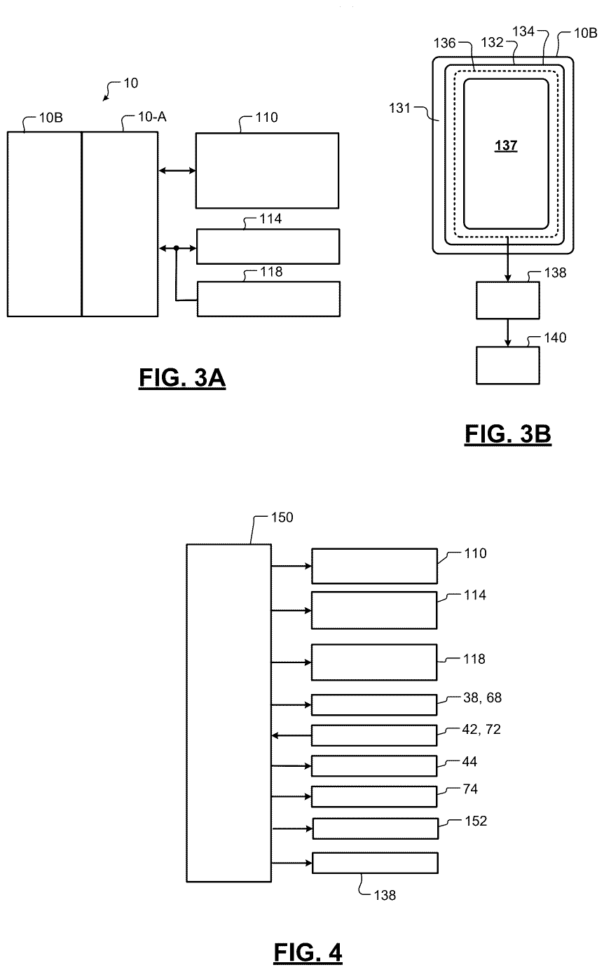

Referring now to FIG. 3A, a positioning device 110 is configured to move one or both mold halves 10A and 10B of the mold 10 to close, partially open (draw back), and/or open the mold 10. A molten plastic source 114 and a chemical foaming agent (CFA) source 118 are configured to supply a mixture of molten plastic and CFA to the mold 10. In some examples, the CFA comprises 0.5 wt % to 5 wt % of the mixture of the molten plastic and the CFA. In some examples, the CFA comprises 2 wt % to 5 wt % of the mixture of the molten plastic and the CFA. In some examples, the CFA comprises 3 wt % to 5 wt % of the mixture of the molten plastic and the CFA since the higher molding temperatures may require additional CFA concentration as compared to lower molding temperatures.

Referring now to FIG. 3B, in some examples, a surface 131 of one or both of the mold halves includes a channel 132 arranged around a cavity 137. A flexible seal material 134 is arranged in the channel 132 to create a seal with the facing surface of the other mold half. In some examples, the flexible seal material 134 is rated for a temperature greater than a temperature of the first fluid. In some examples, the seal 134 is rated for a temperature greater than or equal to 250° F. In some examples, the seal 134 is made of silicon. A channel 136 is located inside of the channel 132 and outside of the cavity 137 and is connected by a valve 138 to a vacuum source 140.

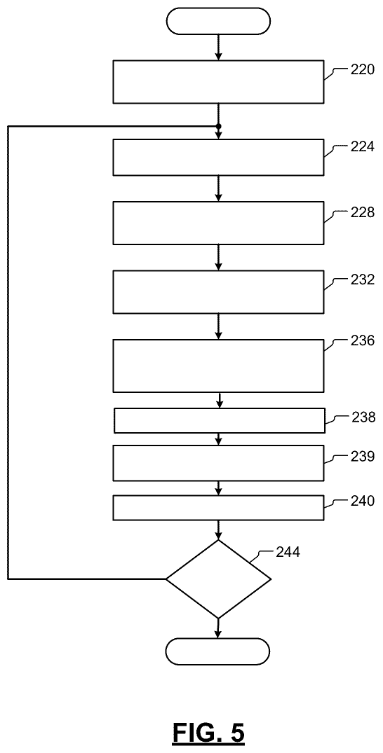

Referring now to FIG. 4, a controller 150 is configured to control the injection molding process. The controller 150 is configured to control the valves 38 and 68 of the liquid delivery system 32 to supply the first liquid to heat the cavity side of the mold and the second liquid to cool the cavity side of the mold during each cycle. In some examples, the controller 150 is configured to receive sensed temperatures from temperature sensors 42 and 72 to control the heater 44 and/or chiller 74, respectively. The controller 150 is configured to control the positioning device 110 to open and close the mold. The controller 150 is configured to control the molten plastic source 114 and the CFA source 118 to provide the mixture and deliver it to the cavity. The ejector 152 includes one or more pins that extend and retract, a lever, or another device. The controller 150 selectively controls the valve 138 to provide vacuum to the channel 136. In some examples, vacuum is supplied during filling and ended prior to core back movement of the mold halves.

Referring now to FIG. 5, a method for molding a part according to the present disclosure is shown. At 220, first liquid is supplied to the cavity side of the mold. At 224, the mold halves are closed. In some examples, the heated fluid is supplied before, during, or after the mold is closed. At 228, molten plastic with the CFA is injected into the mold cavity. At 232, the mold halves are moved apart by a predetermined distance (e.g., 0.5 mm to 1.5 mm). At 236, the second liquid is supplied to the cavity side of the mold. At 238, the mold is opened. At 239, the first fluid is supplied to the mold half on the cavity side. At 240, the molded part is ejected. At 244, the method determines whether another part is to be molded. If true, the method repeats. Otherwise, the method ends.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A core-back injection molding tool, comprising:
a mold including a first mold half and a second mold half defining a cavity there between;
a positioning device configured to move at least one of the first mold half and the second mold half;
a molten plastic source;
a chemical foaming agent (CFA) source;
a liquid delivery system configured to deliver one of a first liquid having a first temperature and a second liquid having a second temperature to a channel defined in the first mold half;
a controller configured to:
supply the first liquid from the liquid delivery system to the channel of the first mold half;
close the first mold half and the second mold half using the positioning device;
supply a mixture of a molten plastic from the molten plastic source and CFA from the CFA source to the cavity;
open one of the first mold half and the second mold half by a predetermined distance using the positioning device;
supply the second liquid from the liquid delivery system to the channel of the first mold half;
open the mold using the positioning device; and
eject a molded part.

2. The core-back injection molding tool of claim 1, wherein the first temperature is in a range from 200° F. to 250° F.

3. The core-back injection molding tool of claim 1, wherein the second temperature is in a range from 32° F. to 90° F.

4. The core-back injection molding tool of claim 1, wherein the CFA comprises 0.5 wt % to 5 wt % of the mixture.

5. The core-back injection molding tool of claim 1, wherein:
the molded part has a finished side and an opposite side,
the first mold half corresponds to the finished side, and
the liquid delivery system selectively delivers the first liquid and the second liquid to the first mold half.

6. The core-back injection molding tool of claim 5, wherein the second mold half is moved the predetermined distance relative to the first mold half.

7. The core-back injection molding tool of claim 1, wherein the predetermined distance is in a range from 0.5 mm to 1.5 mm.

8. The core-back injection molding tool of claim 2, wherein:
one of the first mold half and the second mold half includes a first channel arranged around the cavity,
a flexible seal material is arranged in the first channel,
the flexible seal material is rated for use at a temperature greater than or equal to 250° F.

9. The core-back injection molding tool of claim 1, wherein a portion of the cavity of the first mold half includes a surface grain having a depth that is in a range from 70% to 85% of a final grain depth of the molded part.

10. The core-back injection molding tool of claim 1, further comprising:
a liquid source configured to deliver a third fluid to channels of the second mold half, wherein a third temperature of the third fluid is less than the first temperature of the first liquid and greater than the second temperature of the second liquid.

11. A method for molding a part, comprising:
providing a mold including a first mold half and a second mold half defining a mold cavity there between;
supplying a first liquid having a first temperature to a channel of the first mold half;
closing the first mold half and the second mold half;
supplying a mixture including molten plastic and a chemical foaming agent (CFA) to the mold cavity;
opening one of the first mold half and the second mold half by a predetermined distance;
supplying a second liquid having a second temperature less than the first temperature to the channel of the first mold half;
opening the mold; and
ejecting the part.

12. The method of claim 11, wherein the first temperature is in a range from 200° F. to 250° F.

13. The method of claim 11, wherein the second temperature is in a range from 32° F. to 90° F.

14. The method of claim 11, wherein the CFA comprises 0.5 wt % to 5 wt % of a mixture.

15. The method of claim 11, wherein:
the molded part has a finished side and an opposite side,
the first mold half corresponds to the finished side, and
the first liquid and the second liquid are delivered to the first mold half.

16. The method of claim 15, wherein the second mold half is moved by the predetermined distance relative to the first mold half.

17. The method of claim 11, wherein the predetermined distance is in a range from 0.5 mm to 1.5 mm.

18. The method of claim 11, wherein a portion of the mold cavity of the first mold half includes a surface grain having a depth that is in a range from 70% to 85% of a final grain depth of the molded part.

19. The method of claim 11, further comprising delivering a third fluid to a channel defined by the second mold half.

20. The method of claim 19, wherein a third temperature of the third fluid is less than the first temperature of the first liquid and greater than the second temperature of the second liquid.
